(19) United States
(12) Patent Application Publication
(10) Pub. No.: US 2026/0070549 A1
(43) Pub. Date: Mar. 12, 2026

(54) METHOD FOR CONTROLLING VEHICLE DRIVING AND APPARATUS THEREOF

(71) Applicant: HYUNDAI MOBIS CO., LTD., Seoul (KR)

(72) Inventors: Tae Hyun KIM, Yongin-si (KR); In Seok KIM, Yongin-si (KR); Hyung June CHOI, Yongin-si (KR); Ho In JUNG, Yongin-si (KR)

(73) Assignee: HYUNDAI MOBIS CO., LTD., Seoul (KR)

(21) Appl. No.: 19/311,453

(22) Filed: Aug. 27, 2025

(30) Foreign Application Priority Data
Sep. 10, 2024 (KR) 10-2024-0123196

(51) Int. Cl. B60W 30/14; G06V 10/26; G06V 20/56; G06V 20/58

(52) U.S. Cl. CPC B60W 30/143; G06V 10/26; G06V 20/58; G06V 20/588; B60W 2420/403; B60W 2552/53; B60W 2554/4044; B60W 2554/4045; B60W 2554/80

(57) ABSTRACT

A method of controlling vehicle driving and an apparatus thereof. The method includes recognizing an adjacent vehicle driving in an adjacent lane, analyzing recognition elements for the adjacent vehicle and relationship elements for relationship between the adjacent vehicle and a driving lane of a host vehicle, determining whether the adjacent vehicle changes lanes into the driving lane of the host vehicle based on an analysis result of the recognition elements and the relationship elements, and controlling a driving speed of the host vehicle when it is determined that the adjacent vehicle changes lanes into the driving lane of the host vehicle.

### CROSS-REFERENCE TO RELATED APPLICATION

This application claims the benefit of priority to Korean Patent Application No. 10-2024-0123196, filed in the Korean Intellectual Property Office on Sep. 10, 2024, the entire contents of which are incorporated herein by reference.

### TECHNICAL FIELD

The present disclosure relates to a technology for controlling vehicle driving, and more particularly, to a method of controlling vehicle driving and an apparatus thereof capable of controlling the driving of a host vehicle by determining in advance whether a vehicle driving in an adjacent lane is to change lanes to the driving lane of the host vehicle.

### BACKGROUND

A smart cruise control (SCC) system is a driving assistance system that recognizes a front vehicle through a front camera of a host vehicle and the distance from the front vehicle through a front radar, and controls the speed of the host vehicle to maintain the distance set by a user. Recently, the SCC system has been developed by adding various functions, such as advanced smart cruise control (ASCC), which adds a stop-and-go function to SCC, and NSCC, which adds a function of referring to road information from a navigation system when driving.

In addition, there is a function of reducing the SCC speed of a host vehicle when an adjacent vehicle changing lanes in an adjacent lane is detected.

The SCC system, which utilizes a front corner radar capable of detecting adjacent vehicles in adjacent lanes, has passive system characteristics because the host vehicle may respond only after an approaching adjacent vehicle is detected due to the characteristics of the radar sensor. In addition, there is a limitation that it does not take into account cases where an adjacent vehicle changes lanes behind the host vehicle.

### SUMMARY

The present disclosure has been made to solve the above-mentioned problems occurring in the prior art while advantages achieved by the prior art are maintained intact.

One aspect of the present disclosure provides a method of controlling vehicle driving and an apparatus thereof capable of controlling the driving of a host vehicle by determining in advance whether a vehicle driving in an adjacent lane is to change lanes to the driving lane of the host vehicle.

Another aspect of the present disclosure provides a method of controlling vehicle driving and an apparatus thereof capable of controlling the driving speed of a host vehicle to facilitate entry of an adjacent vehicle into the driving lane of the host vehicle.

The technical problems to be solved by the present disclosure are not limited to the aforementioned problems, and any other technical problems not mentioned herein will be clearly understood from the following description by those skilled in the art to which the present disclosure pertains.

According to one aspect of the present disclosure, a method of controlling vehicle driving includes recognizing an adjacent vehicle driving in an adjacent lane, analyzing recognition elements for the adjacent vehicle and relationship elements for relationship between the adjacent vehicle and a driving lane of a host vehicle, determining whether the adjacent vehicle changes lanes into the driving lane of the host vehicle based on an analysis result of the recognition elements and the relationship elements, and controlling a driving speed of the host vehicle when it is determined that the adjacent vehicle changes lanes into the driving lane of the host vehicle.

According to an embodiment, determining whether the adjacent vehicle changes lanes may include assigning a score to each of the recognition elements and the relationship elements based on the analysis result, and determining whether the adjacent vehicle changes lanes into the driving lane of the host vehicle based on the score assigned to each of the recognition elements and the relationship elements.

According to an embodiment, controlling the driving speed of the host vehicle may include determining an control amount of the driving speed based on a sum of scores assigned to the recognition elements and the relationship elements when it is determined that the adjacent vehicle changes lanes into the driving lane of the host vehicle, and controlling the driving speed of the host vehicle based on the control amount of the driving speed.

According to an embodiment, controlling the driving speed of the host vehicle may include controlling the driving speed such that the host vehicle decelerates when it is determined that the adjacent vehicle changes lanes in front of the host vehicle, and controlling the driving speed such that the host vehicle accelerates when it is determined that the adjacent vehicle changes lanes to a rear of the host vehicle.

According to an embodiment, analyzing the recognition elements and the relationship elements may include analyzing at least two or more elements among a driving direction angle of the adjacent vehicle, a tire area of the adjacent vehicle, a distance between the adjacent vehicle and a line between the adjacent vehicle and the host vehicle, a degree of obscuration of a lane of the host vehicle by the adjacent vehicle, and an obscuration area between a recognition box of the adjacent vehicle and the driving lane of the host vehicle.

According to another aspect of the present disclosure, an apparatus for controlling vehicle driving includes a recognition device that recognizes an adjacent vehicle driving in an adjacent lane, an analysis device that analyzes recognition elements for the adjacent vehicle and relationship elements for relationship between the adjacent vehicle and a driving lane of a host vehicle, a determination device that determines whether the adjacent vehicle changes lanes into the driving lane of the host vehicle based on an analysis result of the recognition elements and the relationship elements, and a controller that controls a driving speed of the host vehicle when it is determined that the adjacent vehicle changes lanes into the driving lane of the host vehicle.

According to an embodiment, the determination device may assign a score to each of the recognition elements and the relationship elements based on the analysis result, and determine whether the adjacent vehicle changes lanes into the driving lane of the host vehicle based on the score assigned to each of the recognition elements and the relationship elements.

According to an embodiment, the controller may determine an control amount of the driving speed based on a sum of scores assigned to the recognition elements and the relationship elements when it is determined that the adjacent vehicle changes lanes into the driving lane of the host vehicle, and control the driving speed of the host vehicle based on the control amount of the driving speed.

According to an embodiment, the controller may control the driving speed such that the host vehicle decelerates when it is determined that the adjacent vehicle changes lanes in front of the host vehicle, and control the driving speed such that the host vehicle accelerates when it is determined that the adjacent vehicle changes lanes to a rear of the host vehicle.

According to an embodiment, the analysis device may analyze at least two or more elements among a driving direction angle of the adjacent vehicle, a tire area of the adjacent vehicle, a distance between the adjacent vehicle and a line between the adjacent vehicle and the host vehicle, a degree of obscuration of a lane of the host vehicle by the adjacent vehicle, and an obscuration area between a recognition box of the adjacent vehicle and the driving lane of the host vehicle.

The features briefly summarized above with respect to the present disclosure are merely exemplary aspects of the detailed description of the present disclosure described below and do not limit the scope of the present disclosure.

### BRIEF DESCRIPTION OF THE DRAWINGS

The above and other objects, features and advantages of the present disclosure will be more apparent from the following detailed description taken in conjunction with the accompanying drawings:

FIG. 1 is a flowchart illustrating an operation of a method of controlling vehicle driving according to an embodiment of the present disclosure;

FIG. 2 is a diagram illustrating an operation of calculating a distance between an adjacent vehicle and a lane of a host vehicle;

FIG. 3 is a diagram illustrating an example of a process of calculating the degree to which the lane of a host vehicle is obscured by an adjacent vehicle;

FIG. 4 is a diagram illustrating an example of a process of calculating an obscuration area where the driving lane of a host vehicle is obscured by a recognition box of an adjacent vehicle;

FIG. 5 is a diagram illustrating an example of a process of calculating the driving direction angle of an adjacent vehicle;

FIG. 6 is a diagram illustrating an example of a process of calculating a tire area of an adjacent vehicle;

FIG. 7 is a diagram illustrating an example of a process of controlling the driving speed of a host vehicle based on scores assigned to each element;

FIG. 8 is a block diagram illustrating the configuration of an apparatus for controlling vehicle driving according to another embodiment of the present disclosure; and

FIG. 9 is a block diagram illustrating a computing system for executing a method of controlling vehicle driving according to an embodiment of the present disclosure.

### DETAILED DESCRIPTION

Hereinafter, various embodiments of the inventive concept will be described in detail with reference to the accompanying drawings, so that those skilled in the art can easily carry out the inventive concept. However, the inventive concept is not limited to the embodiments set forth herein and may be modified variously in many different forms.

In describing the embodiments of the present specification, when a specific description of the related art is deemed to obscure the subject matter of the embodiments of the present specification, the detailed description will be omitted. In the drawings, the portions irrelevant to the description will not be shown in order to make the present disclosure clear.

It will be understood that when an element is referred to as being “connected” or “coupled” to another element, it may be directly connected or indirectly connected to another element. In addition, when some part “includes” or “has” some elements, unless explicitly described to the contrary, it means that other elements may be further included but not excluded.

Expressions such as “first,” or “second,” and the like, may express their elements regardless of their priority or importance and may be used to distinguish one element from another element but is not limited to these components. Therefore, without departing from the scope of the present disclosure, a first component of one embodiment may be referred to as a second component of another embodiment. Similarly, a second component of one embodiment may be referred to as a first component of another embodiment.

In the present disclosure, components that are distinguished from each other are only for clearly describing characteristics, and do not mean that the components are necessarily separated. That is, a plurality of components may be integrated to form a single hardware or software unit, or a single component may be distributed to form a plurality of hardware or software units. Accordingly, such integrated or distributed embodiments are included in the scope of the present disclosure, even though not mentioned separately.

In the present disclosure, components described in various embodiments do not necessarily mean essential components, and some may be optional components. Therefore, an embodiment composed of a subset of components described in an embodiment is also included in the scope of the present disclosure. In addition, embodiments including other components in addition to the components described in various embodiments are also included in the scope of the present disclosure.

In the present disclosure, expressions of positional relationships used herein, such as upper, lower, left, right, and the like, are described for convenience of description. When viewing the drawings shown in this specification in reverse, the positional relationship described in the specification may be interpreted in the opposite manner.

As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases.

Embodiments of the present disclosure are intended to control the driving speed of a host vehicle, for example, acceleration/deceleration of the host vehicle, by determining in advance whether a vehicle driving in an adjacent lane is to change lanes to the driving lane of the host vehicle.

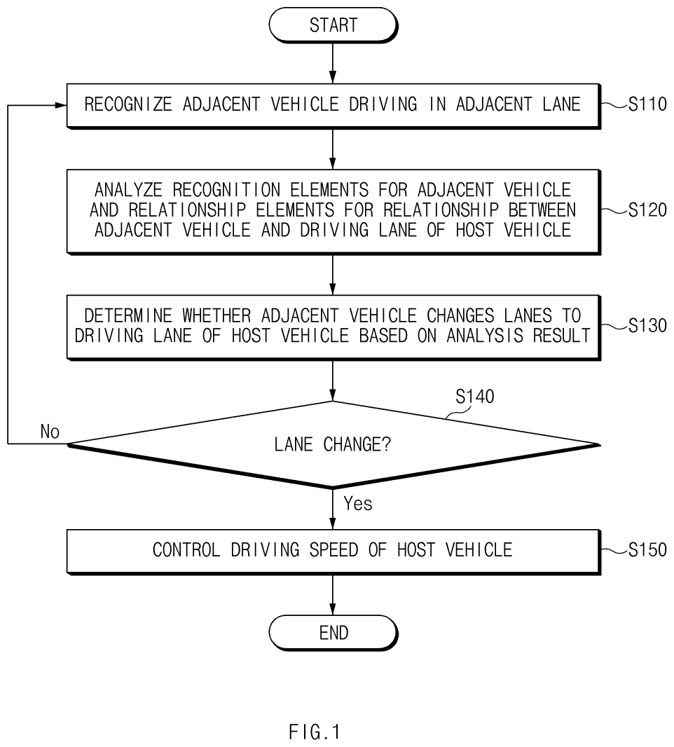

FIG. 1 is a flowchart illustrating an operation of a method of controlling vehicle driving according to an embodiment of the present disclosure.

Referring to FIG. 1, in operation S110, a method of controlling vehicle driving according to an embodiment of the present disclosure recognizes an adjacent vehicle driving in an adjacent lane.

According to an embodiment, in operation S110, various sensors, such as front and rear cameras, provided in a host vehicle may be used to capture images of front adjacent lanes and rear adjacent lanes, and adjacent vehicles driving in the adjacent lanes may be detected in a front image, a rear image, and the like, thereby recognizing adjacent vehicles driving in the adjacent lanes in front or rear of the host vehicle.

Of course, a method according to an embodiment of the present disclosure is not limited or restricted to using the camera described above in a manner of recognizing an adjacent vehicle driving in an adjacent lane, and various schemes of recognizing an adjacent vehicle may be applied.

When an adjacent vehicle driving in an adjacent lane is recognized in operation S110, recognition elements for the adjacent vehicle and relationship elements for the relationship between the adjacent vehicle and the driving lane of the host vehicle are analyzed in operation S120.

In this case, the recognition elements for an adjacent vehicle may include a driving direction angle of the adjacent vehicle, a tire area of the adjacent vehicle, and the like, and the relationship elements for the relationship between the adjacent vehicle and the driving lane of the host vehicle may include the distance between the line between the adjacent vehicle and the host vehicle and the adjacent vehicle (i.e., the distance between the adjacent vehicle and the line of the host vehicle), the degree of obscuration of the lane of the host vehicle by the adjacent vehicle, and the obscuration area between the recognition box of the adjacent vehicle and the driving lane of the host vehicle. The method according to an embodiment of the present disclosure may analyze all of the above-described elements, but may also analyze at least two or more of the above-described elements, and the number of elements to be analyzed may be determined by a business operator or individual providing the technology of the present disclosure.

When the recognition elements for the adjacent vehicle and the relationship elements for the relationship between the adjacent vehicle and the driving lane of the host vehicle are analyzed in operation S120, it is determined in operation S130 whether the adjacent vehicle changes lanes to the driving lane of the host vehicle based on the results of analyzing the recognition elements and the relationship elements, respectively.

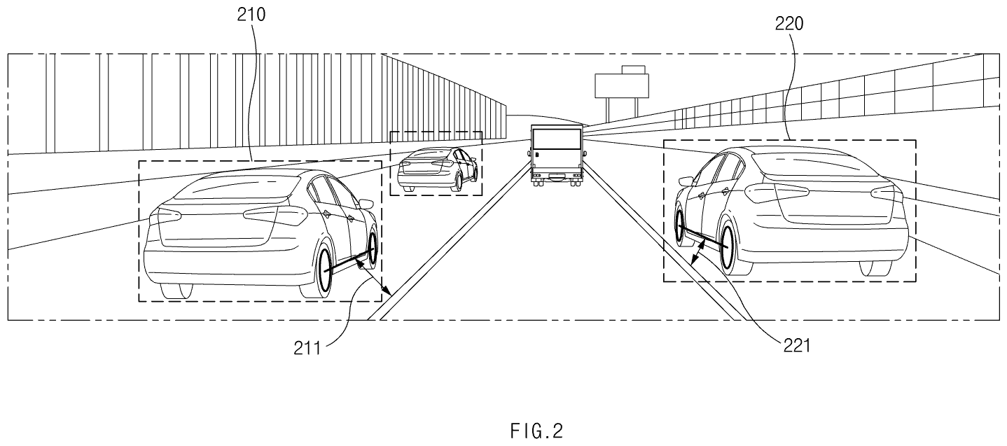

According to an embodiment, in operation S130, scores may be assigned to the recognition elements for the adjacent vehicle and the relationship elements between the adjacent vehicle and the driving lane of the host vehicle based on the analysis results of the recognition elements for the adjacent vehicle and the relationship elements for the relationship between the adjacent vehicle and the driving lane of the host vehicle, and it may be determined whether the adjacent vehicle changes lanes into the driving lane of the host vehicle based on the scores assigned to the recognition elements for the adjacent vehicle and the relationship elements for the relationship between the adjacent vehicle and the driving lane of the host vehicle, respectively. The details will be described with reference to FIGS. 2 to 7.

When it is determined that an adjacent vehicle changes lanes into the driving lane of the host vehicle, in operations S140 and S150, the driving speed of the host vehicle is controlled.

According to an embodiment, when it is determined that the adjacent vehicle changes lanes into the lane of the host vehicle, in operation S150, a control amount of the driving speed, for example, a degree of acceleration or deceleration, may be determined based on the sum of scores assigned to each of the recognition elements for the adjacent vehicle and the relationship elements for the relationship between the adjacent vehicle and the driving lane of the host vehicle, and the driving speed of the host vehicle may be controlled based on the control amount of the driving speed.

According to an embodiment, in operation S150, when it is determined that an adjacent vehicle changes lanes in front of the host vehicle, the driving speed of the host vehicle may be controlled to decelerate, and when it is determined that an adjacent vehicle changes lanes in rear of the host vehicle, the driving speed of the host vehicle may be controlled to accelerate. In this case, the degree of deceleration and the degree of acceleration may be determined based on the sum of scores assigned to each of the recognition elements for the adjacent vehicle and the relationship elements for the relationship between the adjacent vehicle and the driving lane of the host vehicle.

A method according to an embodiment of the present disclosure may determine the control amount for the driving speed of the host vehicle by reflecting not only the above-described recognition elements and relationship elements, but also the distance between the host vehicle and the adjacent vehicle, location information of the host vehicle, for example, information on whether the road on which the host vehicle drives is a national road or an expressway, weather information, and traffic congestion information.

Furthermore, a method according to an embodiment of the present disclosure may calculate the score of each element by reflecting a preset weight according to the priority when priority is given to each of the recognition elements and the relationship elements, and may determine whether an adjacent vehicle changes lanes into the driving lane of the host vehicle or determine the control amount for the driving speed of the host vehicle by using the score to which the weight is reflected. Of course, the priority and weight for each element may vary depending on the current location of the host vehicle, driving speed, and surrounding environmental information.

Furthermore, a method according to an embodiment of the present disclosure may provide an alarm to a driver that the lane change of the adjacent vehicle is to be performed while performing driving control of the host vehicle when it is determined that the adjacent vehicle changes lanes into the lane of the host vehicle.

The method of the present disclosure will be described in more detail with reference to FIGS. 2 to 7 as follows. Hereinafter, FIGS. 2 to 7 illustrate adjacent vehicles in front of a host vehicle, and a scheme of determining whether a front adjacent vehicle changes lanes is described, but the same may be applied to lane changes of a rear adjacent vehicle as well as a front adjacent vehicle.

FIG. 2 is a diagram illustrating an example of a process of calculating a distance between an adjacent vehicle and a lane of a host vehicle.

As illustrated in FIG. 2, the host vehicle recognizes (or calculates) the gap or distance between the driving lane of the host vehicle and a virtual line connecting the centers of the front and rear tires of an adjacent vehicle, as a reference for determining whether the adjacent vehicle is to change lanes into the driving lane of the host vehicle.

In detail, the host vehicle recognizes the driving lane of the host vehicle, that is, the line between the adjacent vehicle and the host vehicle, as a straight line, and recognizes the vehicle in the adjacent lane as the adjacent vehicle.

When an adjacent vehicle is recognized, the front and rear tires of the adjacent vehicle are recognized, the center points of each tire are connected with a virtual line, and the normal distance (interval) from the center point of the virtual line to the adjacent line of the host vehicle is digitized or calculated.

The distance value calculated in such a manner may be assigned as a score for determining the intention of the adjacent vehicle to change lanes. When the distance value is equal to or greater than 20 cm, it may be determined that there is no intention to change lanes and a score of “−1” may be assigned. When the distance value is equal to or less than 10 cm, it may be determined that there is an intention to change lanes and a score of “1” may be assigned. When the distance value is equal to or less than 0 cm, it may be determined that the intention to change lanes is strong and a score of “2” may be assigned. When the distance value is not recognized, it may be determined as unrecognized and a score of “0 (zero)” may be assigned.

For example, in the case of a left adjacent vehicle 210 in FIG. 2, the normal distance from the virtual line connecting the center points of each tire of the left adjacent vehicle to the adjacent lane of the host vehicle is calculated, and when a calculated distance 211 is assumed to be 20 cm or more, it is determined that there is no intention to change lanes and a score of “−1” is assigned to the left adjacent vehicle. On the other hand, in the case of a right adjacent vehicle 220 in FIG. 2, the normal distance from the virtual line connecting the center points of each tire of the right adjacent vehicle to the adjacent lane of the host vehicle is calculated, and when a calculated distance 221 is assumed to be less than 0 (zero) cm, it is determined that the intention to change lanes is strong, and a score of “2” is assigned to the right adjacent vehicle. Of course, the score assigned based on distance may be determined by the business operator or individual providing the technology of the present disclosure.

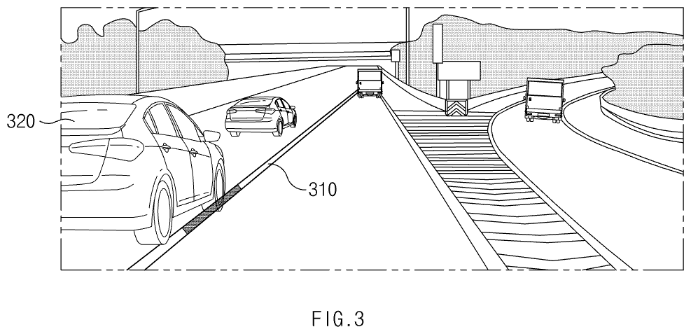

FIG. 3 is a diagram illustrating an example of a process of calculating the degree to which the lane of a host vehicle is obscured by an adjacent vehicle.

As illustrated in FIG. 3, the host vehicle calculates the degree to which its lane is obscured by the adjacent vehicle (or the amount of lane obscuration) as a reference for determining whether the adjacent vehicle is to change lanes into the driving lane of the host vehicle.

In detail, the host vehicle recognizes the driving lane of the host vehicle, that is, the line between the adjacent vehicle and the host vehicle, as a straight line, and quantifies or calculates the degree to which the driving lane of the host vehicle is obscured by the adjacent vehicle.

The degree of obscuration calculated in such a manner may be assigned as a score for determining the intention of the adjacent vehicle to change lanes. When the degree of obscuration is equal to or greater than 5 cm, it may be determined that there is no intention to change lanes and a score of “−1” may be assigned. When the degree of obscuration is equal to or less than 30 cm, it may be determined that there is an intention to change lanes and a score of “1” may be assigned. When the degree of obscuration is equal to or greater than 60 cm, it may be determined that the intention to change lanes is strong and a score of “2” may be assigned. When the degree of obscuration is not recognized, it may be determined as unrecognized and a score of “0 (zero)” may be assigned.

For example, in FIG. 3, when a straight line 310 between the adjacent vehicle and the host vehicle is obscured by a left adjacent vehicle 320 and the degree of obscuration is equal to or greater than 60 cm, it is determined that the intention to change lanes is strong, and a score of “2” is assigned to the left adjacent vehicle 320. Of course, the score assigned based on the degree of obscuration may be determined by the business operator or individual providing the technology of the present disclosure.

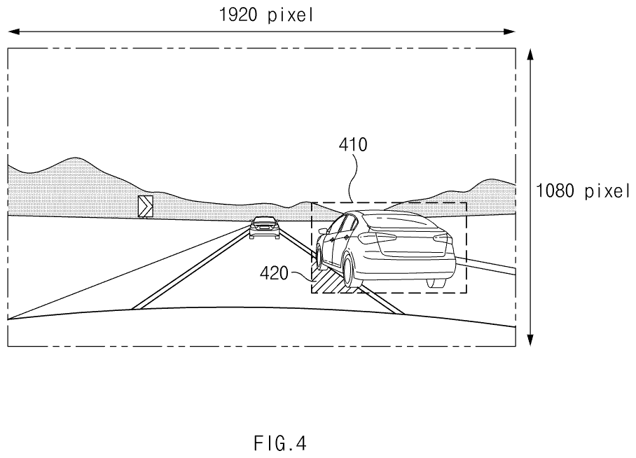

FIG. 4 is a diagram illustrating an example of a process of calculating an obscuration area where the driving lane of a host vehicle is obscured by a recognition box of an adjacent vehicle.

As illustrated in FIG. 4, the host vehicle calculates the obscuration area in which the driving lane of the host vehicle is obscured by the recognition box of an adjacent vehicle, as a reference for determining whether the adjacent vehicle is to change lanes into the driving lane of the host vehicle. In this case, the obscuration area may mean the area (overlap area) where the recognition box and the driving lane of the host vehicle overlap.

In detail, the host vehicle recognizes the driving lane of the host vehicle, that is, the line between the adjacent vehicle and the host vehicle, as a straight line, and digitizes or calculates the obscuration area where the driving lane of the host vehicle is obscured by the recognition box of the adjacent vehicle recognized by the host vehicle. In this case, the obscuration area may be calculated based on the pixels of a captured image.

The obscuration area calculated in such a manner may be assigned as a score for determining the intention of the adjacent vehicle to change lanes. When the obscuration area is equal to or greater than 0 (zero) pixel2, it may be determined that there is no intention to change lanes and a score of “−1” may be assigned. When the obscuration area is equal to or greater than 5,000 pixel2, it may be determined that there is an intention to change lanes and a score of “1” may be assigned. When the obscuration area is equal to or greater than 10,000 pixel2, it may be determined that the intention to change lanes is strong and a score of “2” may be assigned. When the obscuration area is not recognized, it may be determined as unrecognized and a score of “0 (zero)” may be assigned.

For example, in FIG. 4, when it is assumed that the obscuration area between a recognition box 410 of the right adjacent vehicle and the driving lane of the host vehicle, that is, an overlap area 420 is equal to or greater than 5,000 pixel2 and less than 10,000 pixel2, it may be determined that there is an intention to change lanes and a score of “1” may be assigned to the right adjacent vehicle. Of course, the score assigned based on the obscuration area may be determined by the business operator or individual providing the technology of the present disclosure.

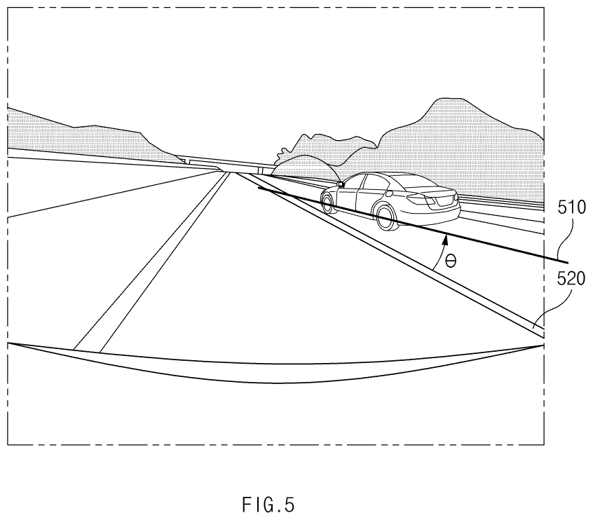

FIG. 5 is a diagram illustrating an example of a process of calculating the driving direction angle of an adjacent vehicle.

As illustrated in FIG. 5, the host vehicle calculates the driving direction angle between the adjacent vehicle and the driving lane of the host vehicle as a reference for determining whether the adjacent vehicle is to change lanes into the driving lane of the host vehicle.

In detail, the host vehicle recognizes the driving lane of the host vehicle, that is, the line between the adjacent vehicle and the host vehicle, as a straight line, recognizes the driving direction of the adjacent vehicle recognized by the host vehicle, and quantifies or calculates the angle between the driving direction of the adjacent vehicle and the driving lane of the host vehicle.

The driving direction angle of the adjacent vehicle calculated in such a manner may be assigned as a score for determining the intention of the adjacent vehicle to change lanes. When the driving direction angle is between −5 and +5 degrees, it may be determined that there is no intention to change lanes and a score of “−1” may be assigned. When the driving direction angle is between −10 and +10 degrees, it may be determined that there is an intention to change lanes and a score of “1” may be assigned. When the driving direction angle is between −15 and +15 degrees, it may be determined that the intention to change lanes is strong and a score of “2” may be assigned. When the driving direction angle is not recognized, it may be determined as unrecognized and a score of “0 (zero)” may be assigned.

For example, in FIG. 3, when the driving direction angle (θ) calculated based on a driving direction 510 of a right adjacent vehicle and a driving lane 520 of the host vehicle is between −15 and +15 degrees, it is determined that the intention to change lanes is strong, and a score of “2” is assigned to the right adjacent vehicle. Of course, the score assigned based on the driving direction angle may be determined by the business operator or individual providing the technology of the present disclosure.

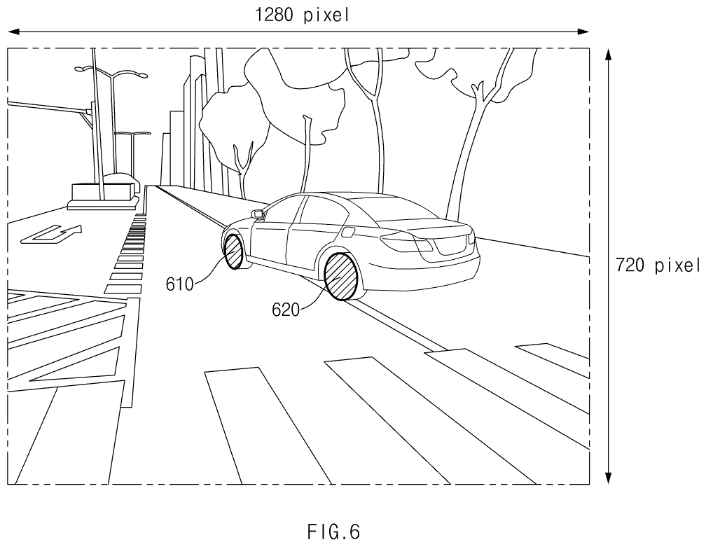

FIG. 6 is a diagram illustrating an example of a process of calculating a tire area of an adjacent vehicle.

As illustrated in FIG. 6, the host vehicle calculates the front and rear tire area of an adjacent vehicle as a reference for determining whether the adjacent vehicle is to change lanes into the driving lane of the host vehicle.

In detail, the host vehicle recognizes the driving lane of the host vehicle, that is, the line between the adjacent vehicle and the host vehicle, as a straight line, and digitizes or calculates the image area occupied by the front and rear tires of the adjacent vehicle recognized by the host vehicle. In this case, the tire area may be calculated based on the pixels of a captured image.

The front and rear tire area calculated in such a manner may be assigned as a score for determining the intention of the adjacent vehicle to change lanes. When the front and rear tire area is equal to or greater than 0 (zero) pixel2, it may be determined that there is no intention to change lanes and a score of “−1” may be assigned. When the front and rear tire area is equal to or greater than 7,000 pixel2, it may be determined that there is an intention to change lanes and a score of “1” may be assigned. When the front and rear tire area is equal to or greater than 10,000 pixel2, it may be determined that the intention to change lanes is strong and a score of “2” may be assigned. When the front and rear tire area is not recognized, it may be determined as unrecognized and a score of “0 (zero)” may be assigned.

For example, in FIG. 6, when it is assumed that the calculated area for front and rear tires 610 and 620 of the right adjacent vehicle is greater than or equal to 7,000 pixel2 and less than 10,000 pixel2, it may be determined that there is an intention to change lanes and a score of “1” may be assigned to the right adjacent vehicle. Of course, the score assigned based on the front and rear tire area may be determined by the business operator or individual providing the technology of the present disclosure.

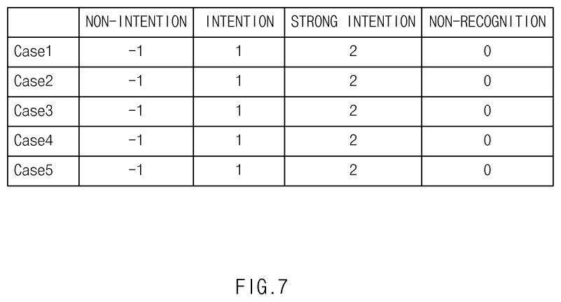

FIG. 7 is a diagram illustrating an example of a process of controlling the driving speed of a host vehicle based on scores assigned to each element. Cases 1 to 5 illustrated in FIG. 7 refer to cases of FIGS. 2 to 6.

As illustrated in FIG. 7, when a score is assigned to each of the recognition elements and the relationship elements, the driving speed of the host vehicle may be controlled based on the sum of the assigned scores. That is, acceleration/deceleration control of the host vehicle in relation to the lane change state of the adjacent vehicle is proportionally performed based on the sum of the lane change intention scores for each case. In the cases of FIGS. 2 to 6, deceleration control is performed.

In FIG. 7, the score for the strongest lane-changing intention is 10 points, the lowest score with lane-changing intention is 1 point, the score for the lowest lane-changing intention is −5 points, the highest score with no lane-changing intention is −1 point, and the score for not recognizing lane-changing intention is 0 (zero) points.

The deceleration control of the host vehicle may be performed based on the expected location of the host vehicle in the driving lane when the adjacent vehicle completes a lane change.

A method according to an embodiment of the present disclosure may proportionally perform host vehicle deceleration control for scores from 1 point to 10 points, where it is determined that there is an intention to change lane, based on the sum of the scores described above.

For example, when the basic deceleration speed of an autonomous vehicle for a front vehicle is 2 seconds, the deceleration control of the host vehicle may be performed differently depending on the total score of lane change intention. According to an embodiment, when the total score of lane change intention is 2 points, deceleration control may be performed for 1.8 seconds, which is obtained by adding 10% to the basic deceleration speed. When the total score of lane change intention is 4 points, deceleration control may be performed for 1.6 seconds, which is obtained by adding 20% to the basic deceleration speed. When the total score of lane change intention is 6 points, deceleration control may be performed for 1.4 seconds, which is obtained by adding 30% to the basic deceleration speed. When the total score of lane change intention is 8, deceleration control may be performed for 1.2 seconds, which is obtained by adding 40% to the basic deceleration speed. When the total score of lane change intention is 10 points, deceleration control may be performed for 1 second, which is obtained by adding 50% to the basic deceleration speed.

As described above, according to a method of controlling vehicle driving according to an embodiment of the present disclosure, it is possible to control the driving speed of the host vehicle by determining in advance whether a vehicle driving in an adjacent lane is to change lanes into the driving lane of the host vehicle, thereby allowing the adjacent vehicle to easily enter the driving lane of the host vehicle.

In addition, according to a method of controlling vehicle driving according to an embodiment of the present disclosure, it is possible to control the driving speed of the host vehicle such that the adjacent vehicle easily enters the driving lane of the host vehicle, thereby reducing the stress of changing lanes with an adjacent vehicle.

In addition, according to a method of controlling vehicle driving according to an embodiment of the present disclosure, it is possible to reduce sudden acceleration and deceleration situations due to lane changes, thereby reducing traffic congestion.

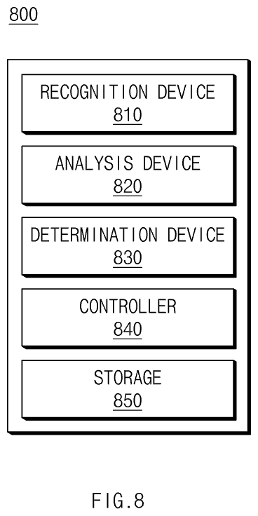

FIG. 8 is a block diagram illustrating the configuration of an apparatus for controlling vehicle driving according to another embodiment of the present disclosure, and conceptually illustrates the configuration of an apparatus that performs the methods of FIGS. 1 to 7.

Referring to FIG. 8, an apparatus 800 for controlling vehicle driving according to another embodiment of the present disclosure includes a recognition device 810, an analysis device 820, a determination device 830, a controller 840, and storage 850.

The storage 850, which is a device for storing all data related to the technology of the present disclosure, may store data such as sensing data acquired by a sensor of a vehicle, image data captured by a vehicle camera, a lane change determination algorithm of an adjacent vehicle, a vehicle driving control algorithm, adjacent vehicle data detected from sensing data, relationship data between an adjacent vehicle and a host vehicle, recognition elements for an adjacent vehicle, relationship elements between an adjacent vehicle and a host vehicle, and the like.

The recognition device 810 recognizes an adjacent vehicle driving in an adjacent lane.

According to an embodiment, the recognition device 810 may use various sensors, such as front and rear cameras, provided in a host vehicle to capture images of front adjacent lanes and rear adjacent lanes, and detect adjacent vehicles driving in the adjacent lanes in a front image, a rear image, and the like, thereby recognizing adjacent vehicles driving in the adjacent lanes in front or rear of the host vehicle.

The analysis device 820 analyzes recognition elements for the adjacent vehicle and relationship elements for the relationship between the adjacent vehicle and the driving lane of the host vehicle.

In this case, the recognition elements for an adjacent vehicle may include a driving direction angle of the adjacent vehicle, a tire area of the adjacent vehicle, and the like, and the relationship elements for the relationship between the adjacent vehicle and the driving lane of the host vehicle may include the distance between the line between the adjacent vehicle and the host vehicle and the adjacent vehicle (i.e., the distance between the adjacent vehicle and the line of the host vehicle), the degree of obscuration of the lane of the host vehicle by the adjacent vehicle, and the obscuration area between the recognition box of the adjacent vehicle and the driving lane of the host vehicle.

The determination device 830 may determine whether the adjacent vehicle changes lanes to the driving lane of the host vehicle based on the results of analyzing the recognition elements and the relationship elements, respectively.

According to an embodiment, the determination device 830 may assign scores to the recognition elements for the adjacent vehicle and the relationship elements between the adjacent vehicle and the driving lane of the host vehicle based on the analysis results of the recognition elements for the adjacent vehicle and the relationship elements for the relationship between the adjacent vehicle and the driving lane of the host vehicle, and may determine whether the adjacent vehicle changes lanes into the driving lane of the host vehicle based on the scores assigned to the recognition elements for the adjacent vehicle and the relationship elements for the relationship between the adjacent vehicle and the driving lane of the host vehicle, respectively.

The controller 840 controls the driving speed of the host vehicle when the determination device 830 determines that an adjacent vehicle changes lanes into the driving lane of the host vehicle.

According to an embodiment, when it is determined that the adjacent vehicle changes lanes into the lane of the host vehicle, the controller 840 may determine a control amount of the driving speed, for example, a degree of acceleration or deceleration, based on the sum of scores assigned to each of the recognition elements for the adjacent vehicle and the relationship elements for the relationship between the adjacent vehicle and the driving lanes of the host vehicle, and may control the driving speed of the host vehicle based on the control amount of the driving speed.

According to an embodiment, when it is determined that an adjacent vehicle changes lanes in front of the host vehicle, the controller 840 may control the driving speed of the host vehicle to decelerate, and when it is determined that an adjacent vehicle changes lanes in rear of the host vehicle, the controller 840 may control the driving speed of the host vehicle to accelerate. In this case, the degree of deceleration and the degree of acceleration may be determined based on the sum of scores assigned to each of the recognition elements for the adjacent vehicle and the relationship elements for the relationship between the adjacent vehicle and the driving lane of the host vehicle.

According to an embodiment, when it is determined that the adjacent vehicle changes lanes into the lane of the host vehicle, the controller 840 may provide an alarm to a driver that the lane change of the adjacent vehicle is to be performed while performing driving control of the host vehicle.

Although the description is omitted in an apparatus according to another embodiment of the present disclosure, the apparatus according to another embodiment of the present disclosure may include all contents described in the methods of FIGS. 1 to 7, which is obvious to those skilled in the art of the disclosure.

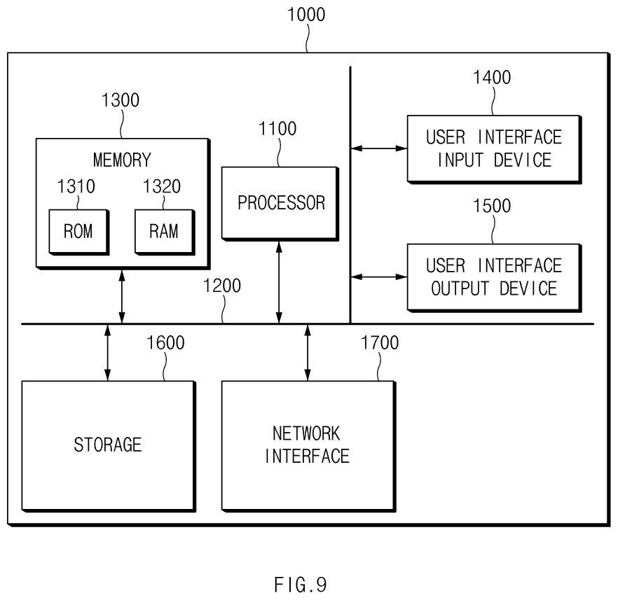

FIG. 9 is a block diagram illustrating a computing system for executing a method of controlling vehicle driving according to an embodiment of the present disclosure.

Referring to FIG. 9, as described above, the method of controlling vehicle driving according to an embodiment of the present disclosure may be implemented through a computing system. A computing system 1000 may include at least one processor 1100, a memory 1300, a user interface input device 1400, a user interface output device 1500, storage 1600, and a network interface 1700, which are connected through a system bus 1200.

The processor 1100 may be a central processing unit (CPU) or a semiconductor device that processes instructions stored in the memory 1300 and/or the storage 1600. The memory 1300 and the storage 1600 may include various volatile or nonvolatile storage media. For example, the memory 1300 may include a read only memory (ROM) 1310 and a random access memory (RAM) 1320.

Accordingly, the processes of the method or algorithm described in relation to the embodiments of the present disclosure may be implemented directly by hardware executed by the processor 1100, a software module, or a combination thereof. The software module may reside in a storage medium (that is, the memory 1300 and/or the storage 1600), such as a RAM memory, a flash memory, a ROM memory, an EPROM memory, an EEPROM memory, a register, a hard disk, a detachable disk, or a CD-ROM. The exemplary storage medium is coupled to the processor 1100, and the processor 1100 may read information from the storage medium and may write information in the storage medium. In another method, the storage medium may be integrated with the processor 1100. The processor 1100 and the storage medium may reside in an application specific integrated circuit (ASIC). The ASIC may reside in a user terminal. In another method, the processor 1100 and the storage medium may reside in the user terminal as an individual component.

According to the present disclosure, by determining in advance whether a vehicle driving in an adjacent lane is to change lanes into the driving lane of the host vehicle and controlling the driving speed of the host vehicle, the adjacent vehicle may easily enter the driving lane of the host vehicle.

According to the present disclosure, by controlling the driving speed of a host vehicle to allow an adjacent vehicle to easily enter the driving lane of the host vehicle, the stress of changing lanes of the adjacent vehicle may be reduced.

According to the present disclosure, sudden acceleration and deceleration situations due to lane changes may be reduced, thereby reducing traffic congestion.

Effects obtained by various embodiments of the disclosure may not be limited to the above, and other effects will be clearly understandable to those having ordinary skill in the art from the following disclosures.

Although exemplary embodiments of the present disclosure have been described for illustrative purposes, those skilled in the art will appreciate that various modifications, additions and substitutions are possible, without departing from the scope and spirit of the disclosure. Therefore, the exemplary embodiments disclosed in the present disclosure are provided for the sake of descriptions, not limiting the technical concepts of the present disclosure, and it should be understood that such exemplary embodiments are not intended to limit the scope of the technical concepts of the present disclosure. The protection scope of the present disclosure should be understood by the claims below, and all the technical concepts within the equivalent scopes should be interpreted to be within the scope of the right of the present disclosure.

What is claimed is:

1. A method of controlling vehicle driving, the method comprising:
recognizing an adjacent vehicle driving in an adjacent lane;
analyzing recognition elements for the adjacent vehicle and relationship elements for relationship between the adjacent vehicle and a driving lane of a host vehicle;
determining whether the adjacent vehicle changes lanes into the driving lane of the host vehicle based on an analysis result of the recognition elements and the relationship elements; and
controlling a driving speed of the host vehicle when it is determined that the adjacent vehicle changes lanes into the driving lane of the host vehicle.

2. The method of claim 1, wherein determining whether the adjacent vehicle changes lanes includes:
assigning a score to each of the recognition elements and the relationship elements based on the analysis result; and
determining whether the adjacent vehicle changes lanes into the driving lane of the host vehicle based on the score assigned to each of the recognition elements and the relationship elements.

3. The method of claim 2, wherein controlling the driving speed of the host vehicle includes:
determining an control amount of the driving speed based on a sum of scores assigned to the recognition elements and the relationship elements when it is determined that the adjacent vehicle changes lanes into the driving lane of the host vehicle; and
controlling the driving speed of the host vehicle based on the control amount of the driving speed.

4. The method of claim 2, wherein controlling the driving speed of the host vehicle includes controlling the driving speed such that the host vehicle decelerates when it is determined that the adjacent vehicle changes lanes in front of the host vehicle, and controlling the driving speed such that the host vehicle accelerates when it is determined that the adjacent vehicle changes lanes to a rear of the host vehicle.

5. The method of claim 1, wherein analyzing the recognition elements and the relationship elements includes analyzing at least two or more elements among a driving direction angle of the adjacent vehicle, a tire area of the adjacent vehicle, a distance between the adjacent vehicle and a line between the adjacent vehicle and the host vehicle, a degree of obscuration of a lane of the host vehicle by the adjacent vehicle, and an obscuration area between a recognition box of the adjacent vehicle and the driving lane of the host vehicle.

6. An apparatus for controlling vehicle driving, the apparatus comprising:
a recognition device configured to recognize an adjacent vehicle driving in an adjacent lane;
an analysis device configured to analyze recognition elements for the adjacent vehicle and relationship elements for relationship between the adjacent vehicle and a driving lane of a host vehicle;
a determination device configured to determine whether the adjacent vehicle changes lanes into the driving lane of the host vehicle based on an analysis result of the recognition elements and the relationship elements; and
a controller configured to control a driving speed of the host vehicle when it is determined that the adjacent vehicle changes lanes into the driving lane of the host vehicle.

7. The apparatus of claim 6, wherein the determination device is configured to assign a score to each of the recognition elements and the relationship elements based on the analysis result, and determine whether the adjacent vehicle changes lanes into the driving lane of the host vehicle based on the score assigned to each of the recognition elements and the relationship elements.

8. The apparatus of claim 7, wherein the controller is configured to determine an control amount of the driving speed based on a sum of scores assigned to the recognition elements and the relationship elements when it is determined that the adjacent vehicle changes lanes into the driving lane of the host vehicle, and control the driving speed of the host vehicle based on the control amount of the driving speed.

9. The apparatus of claim 7, wherein the controller is configured to control the driving speed such that the host vehicle decelerates when it is determined that the adjacent vehicle changes lanes in front of the host vehicle, and control the driving speed such that the host vehicle accelerates when it is determined that the adjacent vehicle changes lanes to a rear of the host vehicle.

10. The apparatus of claim 6, wherein the analysis device is configured to analyze at least two or more elements among a driving direction angle of the adjacent vehicle, a tire area of the adjacent vehicle, a distance between the adjacent vehicle and a line between the adjacent vehicle and the host vehicle, a degree of obscuration of a lane of the host vehicle by the adjacent vehicle, and an obscuration area between a recognition box of the adjacent vehicle and the driving lane of the host vehicle.
